(19) United States
(12) Patent Application Publication
(10) Pub. No.: US 2019/0035020 A1
(43) Pub. Date: Jan. 31, 2019

(54) METHOD FOR ASSIGNING A TRADE INSTRUCTION TO A TRADING SYSTEM BELONGING TO A FINANCIAL INSTITUTION

(71) Applicant: HCL TECHNOLOGIES LIMITED, Noida (IN)

(72) Inventors: Ritesh JAIN, Noida (IN); Ajay SINGH, Noida (IN)

(21) Appl. No.: 16/039,393

(22) Filed: Jul. 19, 2018

(30) Foreign Application Priority Data
Jul. 27, 2017 (IN) 201711026706

(51) Int. Cl. G06Q 40/04; G06N 99/00

(52) U.S. Cl. CPC G06Q 40/04; G06F 17/28; G06N 99/005

(57) ABSTRACT

Disclosed is a system for assigning a trade instruction, in a structured data format, to a trading system capable of processing a trade, wherein the trading system belongs to a financial institution. A data receiving module receives trading information comprising one or more trading keywords from at least one data source in at least one unstructured data format. A data processing module processes the trading information to extract the one or more trading keywords and metadata, associated to the one or more trading keywords, in a structured data format. The data processing module analyzes the one or more trading keywords to categorize the trading information into a trading category. A validation module validates the categorization of the trading information upon referring to a trade domain ontology. A trading module assigns the trading information to a trading system for processing the trade in the trading category upon validating the categorization.

### CROSS REFERENCE TO RELATED APPLICATIONS

This present application claims benefit from Indian Complete Patent Application No 201711026706 filed on 27 Jul. 2017 the entirety of which is hereby incorporated by reference

### TECHNICAL FIELD

The present subject matter described herein, in general, relates to trade processing. More particularly, a system and method for assigning a trade instruction, to a trading system capable of processing a trade, in a structured data format.

### BACKGROUND

Trade processing for a financial institution is a time critical and requires a lot of human skills for processing a trade in an accurate and timely manner. Since any trade involves large financial transaction; any human error(s) may lead to huge loss for an investor. Conventionally, the trade processing is taken care by a custodian on behalf of the investor. Generally, the investor trusts the custodian as he/she have skilled resources with domain knowledge to process the trade on behalf of the investor. These resources understand a requirement of the investor and thereby process the trade in an intended trade instrument as prescribed in the requirement.

Since the trade instruction is received, as of now, in various unstructured data formats including but, not limited to, fax, email (with attachments), digitally in the system, hand written instructions, there is an inherent risk of incorrect or delayed trade being processed because of human fatigue or instructions getting missed.

In addition to the above, the requirement is provided to the custodian by using two channels. First channel, where messages get transmitted electronically by using a bank digital system and hence require very little manual intervention. Second channel, where users send the requirement to the custodian in the unstructured data formats. These, trade instruction, are either handwritten or typed or mix of handwritten and typed data in various formats like pdf and images files. While the conventional system for digital interfaces are available, challenges lie where the trade instruction is not provided directly to the bank digital system and users send the data via the second channel.

### SUMMARY

Before the present systems and methods, are described, it is to be understood that this application is not limited to the particular systems, and methodologies described, as there can be multiple possible embodiments which are not expressly illustrated in the present disclosure. It is also to be understood that the terminology used in the description is for the purpose of describing the particular versions or embodiments only, and is not intended to limit the scope of the present application. This summary is provided to introduce concepts related to systems and methods for assigning a trade instruction, in a structured data format, to a trading system capable of processing a trade and the concepts are further described below in the detailed description. This summary is not intended to identify essential features of the claimed subject matter nor is it intended for use in limiting the scope of the claimed subject matter.

In one implementation, a trade instruction processing system for assigning a trade instruction, in a structured data format, to a trading system capable of processing a trade is disclosed. It may be understood that the trading system belongs to a financial institution. The trade instruction processing system may comprise a processor and a memory coupled to the processor. The processor may execute a plurality of modules present in the memory. The plurality of modules may comprise a data receiving module, a data processing module, a validation module, and a trading module. The data receiving module may receive trading information from at least one data source in at least one unstructured data format. The trading information may be received in the form of image or facsimile (containing handwritten information, typed information or a combination of both). It may be understood that the trading information comprises one or more trading keywords. In order to extract the one or more keywords, the data processing module processes the trading information by an image processing using a Long Short Term Memory (LSTM) technique and a reinforcement learning technique. The data processing module, upon processing the image file, extracts the one or more trading keywords and metadata, associated to the one or more trading keywords, from the trading information in a structured data format. In one aspect, the trading information is processed by using at least one data processing technique. The data processing module may further analyze the one or more trading keywords to categorize the trading information into a trading category of a plurality of trading categories. The validation module may validate the categorization of the trading information upon referring to a trade domain ontology. In one aspect, the trade domain ontology may comprise a predefined mapping of the one or more trading keywords and at least one trading category. The trading module may assign the trading information to a trading system for processing a trade in the trading category, as categorized, upon validating the categorization.

In another implementation, a method for assigning a trade instruction, in a structured data format, to a trading system capable of processing a trade is disclosed. It may be understood that the trading system belongs to a financial institution. In order to assign the trade instruction, trading information may be received from at least one data source in at least one unstructured data format. In one aspect, the trading information may be received in the form of image or facsimile (containing handwritten information, typed information or a combination of both). It may be understood that the trading information comprises one or more trading keywords. In order to extract the one or more keywords, the trading information may be processed by an image processing using a Long Short Term Memory (LSTM) technique and a reinforcement learning technique. In one aspect, upon image processing, the trading information may be processed to extract the one or more trading keywords and metadata, associated to the one or more trading keywords, may be extracted from the trading information in a structured data format. In one aspect, the trading information may be processed by using at least one data processing technique. Upon extracting the one or more trading keywords, the one or more trading keywords may be analyzed to categorize the trading information into a trading category of a plurality of trading categories. Subsequently, the categorization of the trading information may be validated upon referring to a trade domain ontology. In one aspect, the trade domain ontology may comprise a predefined mapping of the one or more trading keywords and at least one trading category. Post validation, the trading information may be assigned to a trading system for processing the trade in the trading category, as categorized, upon validating the categorization. In one aspect, the aforementioned method for assigning the trade instruction to the trading system may be performed by a processor using programmed instructions stored in a memory.

In yet another implementation, non-transitory computer readable medium embodying a program executable in a computing device for assigning a trade instruction, in a structured data format, to a trading system capable of processing a trade, wherein the trading system belongs to a financial institution is disclosed. The program may comprise a program code for receiving trading information from at least one data source in at least one unstructured data format. In one aspect, the trading information may be received in the form of image or facsimile (containing handwritten information, typed information or a combination of both). It may be understood that the trading information comprises one or more trading keywords. The program may further comprise a program code for processing the trading information by an image processing using a Long Short Term Memory (LSTM) technique and a reinforcement learning technique. In one aspect, upon processing the trading information, the one or more trading keywords and metadata, associated to the one or more trading keywords, may be extracted from the trading information in a structured data format, wherein the trading information is processed by using at least one data processing technique. The program may further comprise a program code for analyzing the one or more trading keywords to categorize the trading information into a trading category of a plurality of trading categories. The program may further comprise a program code for validating the categorization of the trading information upon referring to a trade domain ontology (220), wherein the trade domain ontology (220) comprises a predefined mapping of the one or more trading keywords and at least one trading category. The program may further comprise a program code for assigning the trading information to a trading system for processing a trade in the trading category, as categorized, upon validating the categorization.

### BRIEF DESCRIPTION OF THE DRAWINGS

The foregoing detailed description of embodiments is better understood when read in conjunction with the appended drawings. For the purpose of illustrating the disclosure, example constructions of the disclosure are shown in the present document; however, the disclosure is not limited to the specific methods and apparatus disclosed in the document and the drawings.

The detailed description is given with reference to the accompanying figures. In the figures, the left-most digit(s) of a reference number identifies the figure in which the reference number first appears. The same numbers are used throughout the drawings to refer like features and components.

FIG. 1 illustrates a network implementation of a trade instruction processing system for assigning a trade instruction, in a structured data format, to a trading system capable of processing a trade, in accordance with an embodiment of the present subject matter.

FIG. 2 illustrates the trade instruction processing system, in accordance with an embodiment of the present subject matter.

FIG. 3 illustrates a data flow within the trade instruction processing system, in accordance with an embodiment of the present subject matter.

FIG. 4 illustrates a method for assigning the trade instruction, in the structured data format, to the trading system capable of processing the trade, in accordance with an embodiment of the present subject matter.

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any systems and methods similar or equivalent to those described herein can be used in the practice, the exemplary, systems and methods are now described. The disclosed embodiments are merely exemplary of the disclosure, which may be embodied in various forms.

Various modifications to the embodiment will be readily apparent to those skilled in the art and the generic principles herein may be applied to other embodiments. However, one of ordinary skill in the art will readily recognize that the present disclosure is not intended to be limited to the embodiments illustrated, but is to be accorded the widest scope consistent with the principles and features described herein.

The proposed invention facilitates to assign a trade instruction, in a structured data format, to a trading system capable of processing a trade is disclosed. It may be understood that the trading system belongs to a financial institution. It may further be understood that the trade instruction comprises trading information including a certain amount to be invested in a specific trade instrument along with other details. The other details may include, but not limited to, date of investment, country, currency and mode of payment.

The proposed invention automates the process of reading and thereby assigning the trade instruction to the trading system for processing the trade. In one aspect, the trade may be processed upon investing the amount in various types of trade instruments. Examples of the trade instruments may include, but not limited to, derivatives, mutual fund, forex, and equity shares. In order to assign the trade, the trading information is received in an unstructured data format. In one aspect, the trading information may be received in the form of image or facsimile (containing handwritten information, typed information or a combination of both). It may be understood that the trading information comprises one or more trading keywords. In order to extract the one or more keywords, the trading information may be processed by an image processing using a Long Short Term Memory (LSTM) technique and a reinforcement learning technique. Upon image processing, the trading information is processed to extract the one or more trading keywords and metadata, associated to the one or more trading keywords, may be extracted from the trading information in a structured data format.

Subsequently, the one or more trading keywords may be analyzed to categorize the trading information into a trading category of a plurality of trading categories, wherein the plurality of categories are having different aspects of the trade instruction that the financial institution has received. Further, the categorization of the metadata may be validated upon referring to a trade domain ontology and thereby the trading information may be assigned to the trading system for processing the trade. Thus, upon assigning the trade system, the proposed invention facilitates to avoid human errors and save efforts spend on manual activities by respective brokers, agents associated to the financial institution.

While aspects of described system and method for assigning the trade instruction, in the structured data format, to the trading system capable of processing the trade may be implemented in any number of different computing systems, environments, and/or configurations, the embodiments are described in the context of the following exemplary system.

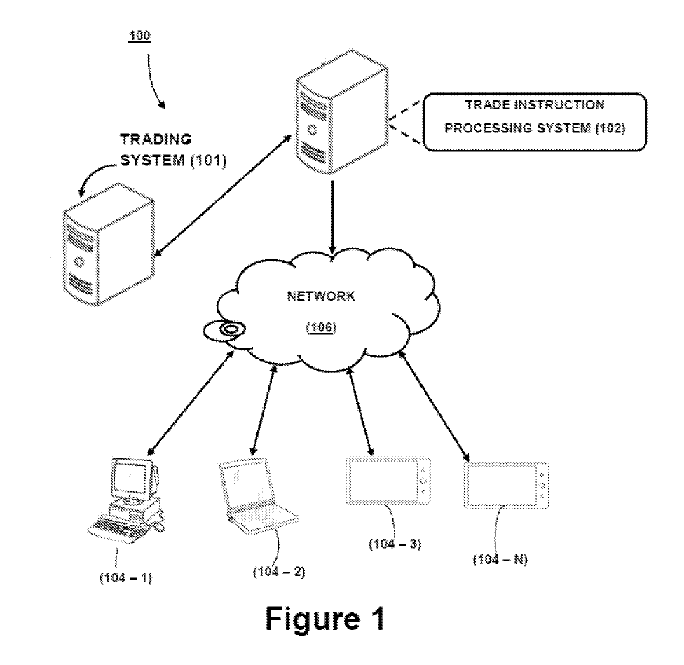

Referring now to FIG. 1, a network implementation 100 of a trade instruction processing system 102 for assigning a trade instruction, in a structured data format, to a trading system 101 capable of processing a trade. In one aspect, the trading system 101 belongs to a financial institution is disclosed. In order to assign the trade instruction, initially, the trade instruction processing system 102 receives trading information comprising one or more trading keywords from at least one data source in at least one unstructured data format. In order to extract the one or more keywords, the trade instruction processing system 102 processes the trading information by an image processing using a Long Short Term Memory (LSTM) technique and a reinforcement learning technique. In one aspect, the image processing system 102 processes the trading information to extract the one or more trading keywords and metadata, associated to the one or more trading keywords, in a structured data format. Upon extracting the one or more trading keywords, the trade instruction processing system 102 analyzes the one or more trading keywords to categorize the trading information into a trading category of a plurality of trading categories. Subsequently, the trade instruction processing system 102 validates categorization of the trading information upon referring to a trade domain ontology. In one aspect, the trade domain ontology may comprise a predefined mapping of the one or more trading keywords and at least one trading category. Post validation, the trade instruction processing system 102 assigns the trading information to a trading system 101 for processing the trade in the trading category, as categorized, upon validating the categorization.

Although the present disclosure is explained considering that the trade instruction processing system 102 is implemented on a server, it may be understood that the trade instruction processing system 102 may be implemented in a variety of computing systems, such as a laptop computer, a desktop computer, a notebook, a workstation, a mainframe computer, a server, a network server, a cloud-based computing environment. It will be understood that the trade instruction processing system 102 may be accessed by multiple users through one or more user devices 104-1, 104-2 . . . 104-N, collectively referred to as user 104 or stakeholders, hereinafter, or applications residing on the user devices 104. In one implementation, the trade instruction processing system 102 may comprise the cloud-based computing environment in which a user may operate individual computing systems configured to execute remotely located applications. Examples of the user devices 104 may include, but are not limited to, a IoT device, IoT gateway, portable computer, a personal digital assistant, a handheld device, and a workstation. The user devices 104 are communicatively coupled to the trade instruction processing system 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Hypertext Transfer Protocol Secure (HTTPS), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

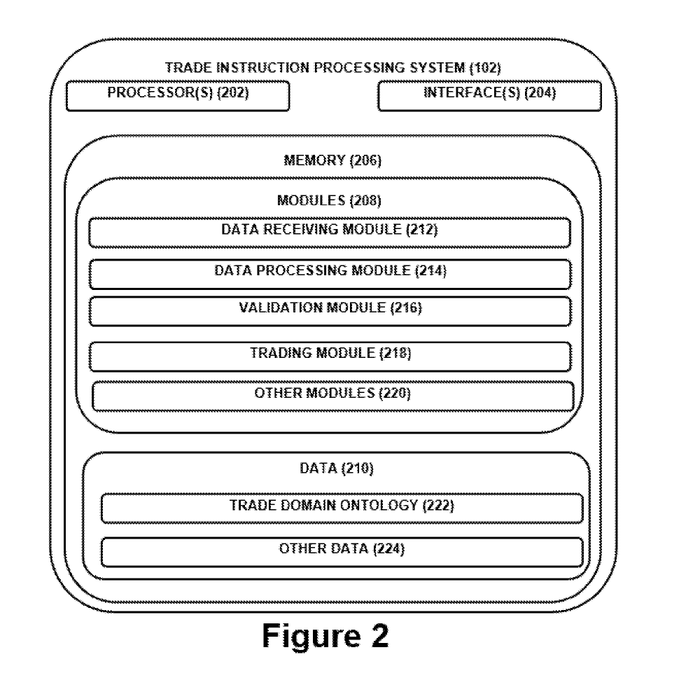

Referring now to FIG. 2, the trade instruction processing system 102 is illustrated in accordance with an embodiment of the present subject matter. In one embodiment, the trade instruction processing system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the trade instruction processing system 102 to interact with the user directly or through the user devices 104. Further, the I/O interface 204 may enable the trade instruction processing system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium or computer program product known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 include routines, programs, objects, components, data structures, etc., which perform particular tasks or implement particular abstract data types. In one implementation, the modules 208 may include a data receiving module 212, a data processing module 214, a validation module 216, a trading module 218, and other modules 220. The other modules 220 may include programs or coded instructions that supplement applications and functions of the trade instruction processing system 102. The modules 208 described herein may be implemented as software modules that may be executed in the cloud-based computing environment of the trade instruction processing system 102.

The data 210, amongst other things, serves as a repository for storing data processed, received, and generated by one or more of the modules 208. The data 210 may also include a trade domain ontology 220 and other data 222. The other data 222 may include data generated as a result of the execution of one or more modules in the other modules 218.

As there are various challenges observed in the existing art, the challenges necessitate the need to build the trade instruction processing system 102 for assigning a trade instruction, in a structured data format, to a trading system 101 capable of processing a trade. In order to facilitate the communication, at first, a user may use the user device 104 to access the trade instruction processing system 102 via the I/O interface 204. The user may register them using the I/O interface 204 to use the trade instruction processing system 102. In one aspect, the user may access the I/O interface 204 of the trade instruction processing system 102. In order to assigning the trade instruction to the trading system 101, the trade instruction processing system 102 may employ the data receiving module 212, the data processing module 214, the validation module 216, and the trading module 218. The detail functioning of the modules is described below with the help of figures.

The data receiving module 212 receives trading information comprising one or more trading keywords from at least one data source in at least one unstructured data format. In one aspect, the trading information may be received in the form of image or facsimile (containing handwritten information, typed information or a combination of both). It may be understood that the trading information comprises one or more trading keywords. Examples of the unstructured data format may include, but not limited to, PDF, JPEG, JPG, email, and facsimile. Upon receipt of the trading information, the data processing module 214 processes the trading information. The trading information may be processed by using at least one data processing technique. Examples of the at least one data processing technique may include, but not limited to, an image processing technique, a machine learning technique, a reinforcement learning technique, and a Natural Language Processing (NLP) technique. In one aspect, the machine learning technique may use a Long Short Term Memory (LSTM) technique. In order to extract the one or more keywords, the data processing module 214 processes the trading information by an image processing using a Long Short Term Memory (LSTM) technique and a reinforcement learning technique. In one embodiment, the data processing module 214 upon processing the image, extracts the one or more trading keywords and metadata in a structured data format.

Upon processing the trading information, the data processing module 214 analyzes the one or more trading keywords along with machine learning techniques to categorize the trading information into a trading category of a plurality of trading categories. In one embodiment, the data processing module 214 categorizes the trading information into the trading category upon implementing the machine learning algorithm on based on the one or more trading keywords as identified from the trading information. Examples of the plurality of trading categories may comprise ‘derivatives’, ‘forex’, ‘mutual fund’, and ‘equity share’ etc. In one embodiment, the trading information may be categorized based on mapping of the one or more trading keywords and one or more parameters associated to the trading category. The trading keywords may comprise at least one of trade type, trade date, account number, broker details, and currency information.

In order to elucidate the functioning of the data receiving module 212 and the data processing module 214, consider an example where the trading information is received from a person ‘X’ via an email, email with attachment or scanned document or any other business application containing these scanned document. It is to be noted that email or the document, comprising the trading information, indicates that an amount of $15000 is to be invested on date Jul. 1, 2017 in mutual funds offered by ‘ABC’ company. From the above email, it has been further noted that the email comprising trading keywords as ‘amount’, ‘date’, ‘mutual funds’ and the metadata as ‘$15000’, ‘July 1^{st}, 2017’, ‘ABC’ company’ for the trading keywords respectively. Since the trading information, as aforementioned, is in unstructured data format, can be handwritten text, typed text or mix of handwritten and typed text the data processing module 214 processes the trading information to extract the trading keywords and the metadata associated to the trading keywords from the source. It may be noted that the trading keywords and the metadata may be extracted by using the Natural Language Processing (NLP) technique. Here the metadata indicates the values pertaining to the trading keywords.

Since the trading information indicates that the trade is to be processed in ‘mutual funds’ category, the data processing module 214 analyzes the trading keywords (i.e. ‘amount’, ‘date’, and ‘mutual funds’) and categorizes the trading information into the ‘mutual fund’ category. Thus, in this manner, the trading information is categorized into at least one trading category.

After categorizing the trading information into the at least one trading category, the validation module 216 validates the categorization of the trading information. The categorization of the trading information is validated to ensure, before investment, that the trading information is categorized in the trading category as intended by the investor. In one aspect, the trading information may be validated upon referring to a trade domain ontology 222. In one embodiment, the trade domain ontology 222 may comprise a predefined mapping of the one or more trading keywords and at least one trading category.

For example, the trade domain ontology database 222 comprises the mapping of the trading keywords (such as ‘mutual fund’, ‘NAV’, “Net Asset Value”, ‘Unit’) with ‘mutual fund’. Similarly, the trade domain ontology 222 comprises the mapping of the trading keywords (such as ‘equity share’ and ‘Sensex’) with ‘equity share’. Post validation, the trading module 218 assigns the trading information, indicating the trade instruction, to a trading system 101 for processing the trade, as categorized, upon validating the categorization.

To elucidate the functioning of the validation module 216 and the trading module 218, consider the example same as aforementioned. Since the trading information, as in the above email, is categorized in the ‘mutual fund’ category, the validation module 216 validates the categorization of the trading information. To validate the categorization, the validation module 216 refers the trade domain ontology 222 to ensure that the trading information is categorized correctly. Upon referring to the trade domain ontology 222, it must be understood that the trading keywords (amount’, ‘date’, and ‘mutual funds’), as identified, are mapped with the ‘mutual fund’ category. This validates that the categorization of the trading information is being done correctly.

Upon validation, the trading module 218 assigns the trading information, including the metadata pertaining to the trading keywords, to a trading system 101 for processing the trade. In other words, the trading module 218 assigns ‘$15000’, ‘July 1^{st}, 2017’, ‘ABC’ company’ (pertaining to the ‘amount’ to be invested, ‘date’ on which the amount to be invested, and ‘mutual fund’ in which the amount to be invested) to the trading system 101 for processing the trade. Thus, in this manner, the trade instruction processing system 102 automates the trading process with robust capabilities, avoid human errors and save efforts spend on manual activities by respective operators.

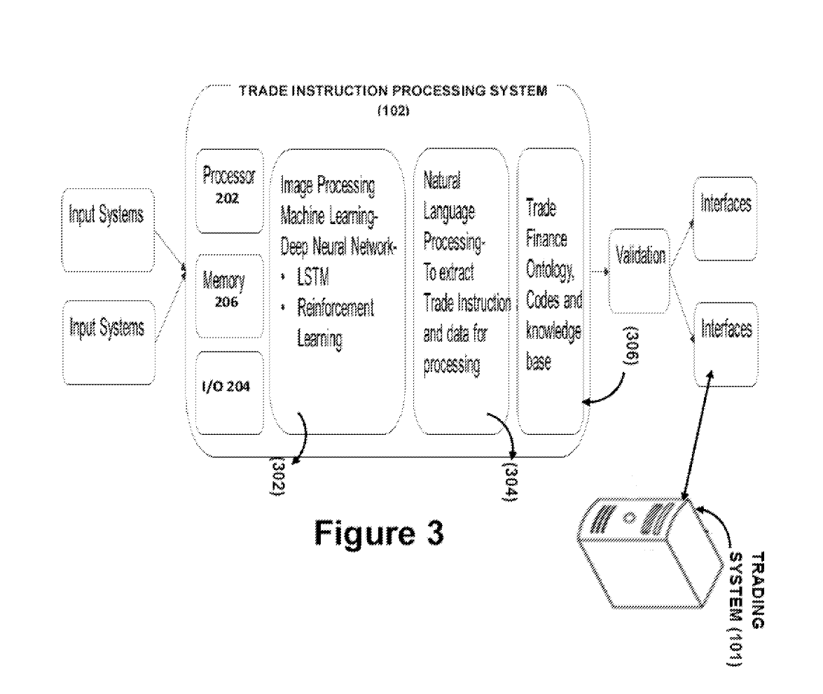

Referring now to FIG. 3, a data flow within the trade instruction processing system 102 for assigning a trade instruction, in a structured data format, to a trading system 101 capable of processing a trade is shown, in accordance with an embodiment of the present subject matter. As shown in the FIG. 3, various input systems, hereinafter referred to as input system 302, are coupled with the trade instruction processing system 102. The data receiving module 212 receives trading information in the form of image or facsimile (containing handwritten information, typed information or a combination of both). In one embodiment, the trading information comprises one or more trading keywords from the input system 302 in at least one unstructured data format. Since the trading information is in the image and unstructured data form, the data processing module 214 processes the trading information by an image processing using a Long Short Term Memory (LSTM) technique and a reinforcement learning technique, as shown in block 302. Subsequently, the data processing module 214 extracts the one or more trading keywords and metadata, associated to the one or more trading keywords, by implementing Natural Language Processing (NLP) technique, as shown in block 304. Post extraction of the one or more trading keywords and the metadata, the data processing module 214 analyzes the one or more trading keywords to categorize the trading information into a trading category. Thereafter, the validation module 216 validates the categorization of the trading information upon referring to a trade domain ontology 220, as shown in block 306. Once the categorization of the trading information is validated, the trading module 218 assigns the trading information, to a trading system 101, via an interface, for processing the trade in the trading category.

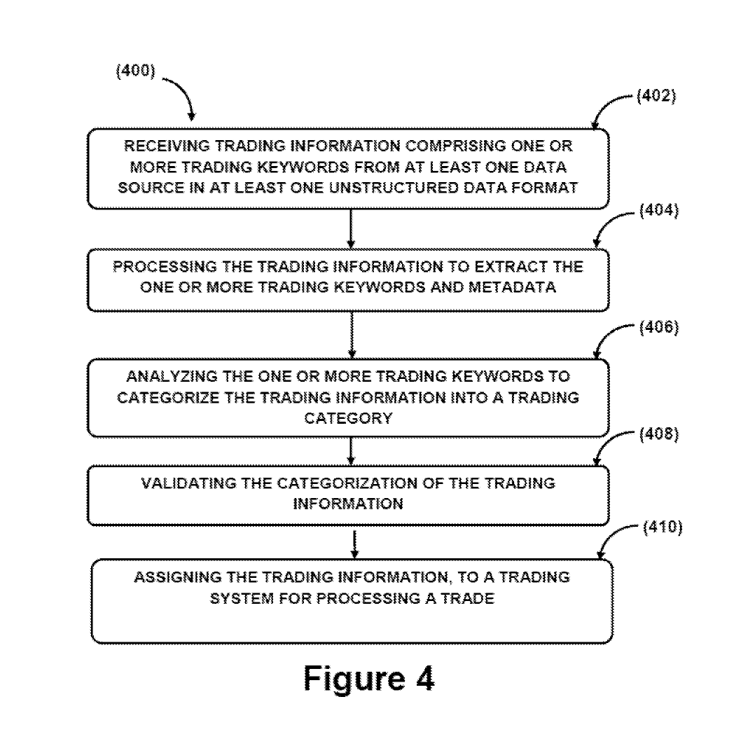

Referring now to FIG. 4, a method 400 for assigning a trade instruction, in a structured data format, to a trading system 101 capable of processing a trade is shown, in accordance with an embodiment of the present subject matter. The method 400 may be described in the general context of computer executable instructions. Generally, computer executable instructions can include routines, programs, objects, components, data structures, procedures, modules, functions, etc., that perform particular functions or implement particular abstract data types. The method 400 may also be practiced in a distributed computing environment where functions are performed by remote processing devices that are linked through a communications network. In a distributed computing environment, computer executable instructions may be located in both local and remote computer storage media, including memory storage devices.

The order in which the method 400 is described is not intended to be construed as a limitation, and any number of the described method blocks can be combined in any order to implement the method 400 or alternate methods. Additionally, individual blocks may be deleted from the method 400 without departing from the spirit and scope of the subject matter described herein. Furthermore, the method can be implemented in any suitable hardware, software, firmware, or combination thereof. However, for ease of explanation, in the embodiments described below, the method 400 may be considered to be implemented as described in the trade instruction processing system 102.

At block 402, trading information comprising one or more trading keywords may be received from at least one data source in at least one unstructured data format. In one implementation, the trading information may be received by the data receiving module 212.

At block 404, the trading information may be processed to extract the one or more trading keywords and metadata, associated to the one or more trading keywords, in a structured data format. In one aspect, the trading information may be processed by using at least one data processing technique. In one implementation, the trading information may be processed by the data processing module 214.

At block 406, the one or more trading keywords may be analyzed to categorize the trading information into a trading category of a plurality of trading categories. In one implementation, the one or more trading keywords may be analyzed by the data processing module 214.

At block 408, the categorization of the trading information may be validated upon referring to a trade domain ontology 220. In one aspect, the trade domain ontology 220 may comprise a predefined mapping of the one or more trading keywords and at least one trading category. In one implementation, the categorization of the trading information may be validated by the validation module 216.

At block 410, the trading information may be assigned to a trading system 101 for processing a trade in the trading category, as categorized, upon validating the categorization. In one implementation, the trading information may be assigned by the trading module 218.

Exemplary embodiments discussed above may provide certain advantages. Though not required to practice aspects of the disclosure, these advantages may include those provided by the following features.

Some embodiments enable a system and a method to automate manual trade processing and analysis.

Some embodiments enable a system and a method to facilitate users with faster services with high accuracy rates.

Some embodiments enable a system and a method to avoid manual efforts on the entire process.

Some embodiments enable a system and a method to avoid human error causing financial impact.

Although implementations for methods and systems for assigning a trade instruction, in a structured data format, to a trading system 101 capable of processing a trade have been described in language specific to structural features and/or methods, it is to be understood that the appended claims are not necessarily limited to the specific features or methods described. Rather, the specific features and methods are disclosed as examples of implementations for assigning the trade instruction, in the structured data format, to the trading system 101.

1. A method for assigning a trade instruction, in a structured data format, to a trading system capable of processing a trade, wherein the trading system belongs to a financial institution, the method comprising:
receiving, by a processor, trading information comprising one or more trading keywords from at least one data source in at least one unstructured or structured data format;
processing, by the processor, the trading information to extract the one or more trading keywords and metadata, associated to the one or more trading keywords, in a structured data format, wherein the trading information is processed by using at least one data processing technique;
analyzing, by the processor, the one or more trading keywords to categorize the trading information into a trading category of a plurality of trading categories;
validating, by the processor, the categorization of the trading information upon referring to a trade domain ontology, wherein the trade domain ontology comprises a predefined mapping of the one or more trading keywords and at least one trading category; and
assigning, by the processor, the trading information to a trading system for processing a trade in the trading category, as categorized, upon validating the categorization.

2. The method of claim 1, wherein the at least one data processing technique comprises an image processing technique, a machine learning technique, a reinforcement learning technique, and a Natural Language Processing (NLP) technique, and wherein the machine learning technique further uses a Long Short Term Memory (LSTM) technique.

3. The method of claim 1, wherein the one or more trading keywords comprises at least one of trade type, trade date, account number, broker details, and currency information.

4. The method of claim 1, wherein the at least one pre-defined trading category is one of derivatives, forex, mutual fund, and equity shares etc.

5. The method of claim 1, wherein the one or more trading keywords and the metadata are extracted by an image processing technique using a Long Short Term Memory (LSTM) technique and a reinforcement learning technique.

6. A trade instruction processing system for assigning a trade instruction, in a structured data format, to a trading system capable of processing a trade, wherein the trading system belongs to a financial institution, the trade instruction processing system comprising:
a processor; and
a memory coupled to the processor, wherein the processor is capable of executing a plurality of modules stored in the memory, and wherein the plurality of modules comprising:
a data receiving module for receiving trading information comprising one or more trading keywords from at least one data source in at least one unstructured data format;
a data processing module for
processing the trading information to extract the one or more trading keywords and metadata, associated to the one or more trading keywords, in a structured data format, wherein the trading information is processed by using at least one data processing technique, and
analyzing the one or more trading keywords to categorize the trading information into a trading category of a plurality of trading categories;
a validation module for validating the categorization of the trading information upon referring to a trade domain ontology, wherein the trade domain ontology comprises a predefined mapping of the one or more trading keywords and at least one trading category; and
a trading module for assigning the trading information, to a trading system for processing a trade in the trading category, as categorized, upon validating the categorization.

7. The trade instruction processing system of claim 6, wherein the at least one data processing technique comprises an image processing technique, a machine learning technique, a reinforcement learning technique, and a Natural Language Processing (NLP) technique, and wherein the machine learning technique further uses a Long Short Term Memory (LSTM) technique.

8. The trade instruction processing system of claim 6, wherein the one or more trading keywords comprises at least one of trade type, trade date, account number, broker details, and currency information.

9. The trade instruction processing system of claim 6, wherein the at least one pre-defined trading category is one of derivatives, forex, mutual fund, and equity share.

10. The trade instruction processing system of claim 6, wherein the data processing module processes the trading information in order to extract the one or more trading keywords and the metadata by an image processing technique using a Long Short Term Memory (LSTM) technique and a reinforcement learning technique.

11. A non-transitory computer readable medium embodying a program executable in a computing device for assigning a trade instruction, in a structured data format, to a trading system capable of processing a trade, wherein the trading system belongs to a financial institution, the program comprising a program code:
a program code for receiving trading information comprising one or more trading keywords from at least one data source in at least one unstructured data format;
a program code for processing the trading information to extract the one or more trading keywords and metadata, associated to the one or more trading keywords, in a structured data format, wherein the trading information is processed by using at least one data processing technique;
a program code for analyzing the one or more trading keywords to categorize the trading information into a trading category of a plurality of trading categories;
a program code for validating the categorization of the trading information upon referring to a trade domain ontology, wherein the trade domain ontology comprises a predefined mapping of the one or more trading keywords and at least one trading category; and
a program code for assigning the trading information to a trading system for processing a trade in the trading category, as categorized, upon validating the categorization.
